(19) United States
(12) Patent Application Publication
(10) Pub. No.: US 2009/0125892 A1
(43) Pub. Date: May 14, 2009

(54) Computer Software Development System and Method

(76) Inventor: Robert Arthur Crewdson, Victoria (AU)

Correspondence Address: Haynes and Boone, LLP;IP Section, 2323 Victory Avenue, SUITE 700, Dallas, TX, 75219, US

(21) Appl. No.: 12/085,129

(22) PCT Filed: Nov. 17, 2006
(86) PCT No.: PCT/AU2006/001712

§ 371 Date: Jan. 22, 2009

(30) Foreign Application Priority Data
Nov. 18, 2005 (AU) 2005906386

(51) Int. Cl. G06F 9/45

(52) U.S. Cl. 717/136

(57) ABSTRACT

A method of implementing a software system on a target-platform is disclosed. The method includes preparing a specification document including statements that collectively specify requirements of the software system. The requirement statements are expressed with language elements of a specification language, and the specification document has an associated source file. In an embodiment, the source file is provided to a driver-code generator which translates the source file into a driver-code file readable by a run-time engine resident on the target-platform to provide, on execution of the driver-code file by the run-time engine, a software system compliant with the specified requirements.

This application claims priority from Australian Provisional Patent Application No. 2005906386 filed on 18 Nov. 2005, the contents of which are to be taken as incorporated herein by this reference.

### FIELD OF INVENTION

The invention broadly relates to methods and tools for computer software system development. In a typical application, the invention may be used to develop and/or maintain business software systems. Such business software systems are sometimes characterised as data processing systems, records management systems, information systems, management information systems, enterprise resource planning systems, customer resource management systems or electronic commerce systems and typically include multiple software sections operating as an integrated software system running on multiple computing devices. These systems typically operate within complex software infrastructures like .NET and Java and include multiple computer programs interacting with one or more database management systems and multiple input/output devices operating over private networks and/or the public internet. The purpose of such software systems is to use available computing resources and human resources to automate business processes.

### BACKGROUND OF THE INVENTION

Modern software infrastructures are very powerful. However, they are also becoming increasingly complex. Consequently, developing new software systems for modern software infrastructures typically involves a complex and time consuming process which can be daunting to even the most experienced software developers.

Indeed, even for software developers familiar with a particular software infrastructure, the range of different software infrastructures for use with different development environments means that it is unlikely that a developer would be knowledgeable in all of those infrastructures. Thus, software developers tend to specialise in a particular software infrastructure. For example, in the .Net environment, the overwhelming majority of development is performed using Microsoft's C#, Visual Basic or C/C++ languages from within an integrated development environment (IDE), such as Microsoft's “Visual Studio”. In the Java environment, a developer will also generally work within an IDE (for example, Borland's Jbuilder) to define forms, generate code and write Java code to build the required programs for implementing a software system

An IDE typically provides a number of services suited to the work of a trained professional developer. Thus, to develop an application of even moderate complexity, the developer must be familiar with the services provided by the IDE and, separately, must also have a great deal of expert technical knowledge regarding object oriented concepts, data management, the target hardware/software infrastructures and complex programming languages.

Further complexity arises where there are separate target hardware and/or software platforms. This further complexity arises because each separate target hardware and/or software platforms will often require a different set of programming tools and skills.

Given the above complexity, it is presently difficult, if not impossible, to commence development of complex software systems until the requirements of the system have been specified. Those requirements are usually specified in a specification document that is understandable to all stake-holders.

Such a document is typically referred to as a “system specification” and will typically include requirements specifying functionality, input/output, business rules and processes, computer hardware and operating software environment, timing and volume constraints, data storage requirements, interfaces, security, and technical details (for example, target platform and database management system details).

In most development processes, the system specification is a pivotal document in the development of a computer software system.

The extent to which a system specification is useful typically depends upon the level of information included in the specification and the way that the information is presented. Unfortunately, the level of detail often varies for different development methods.

For example, rapid application development (RAD) methods (including, “extreme programming”) tend to use minimum system requirements and instead focus on programming to build initial prototypes. Those prototypes are then used as the basis of a specification or to iteratively develop the system until the system owner and end-users are happy. Such an approach can be productive for some systems, but tends to leave the system poorly documented.

On the other hand, sophisticated diagrammatic approaches (such as, Unified Modelling Language) enable formal analysis of requirements prior to development. However, the requirements are usually expressed in a way that renders them difficult for all stakeholders to understand. For example, diagrams representing abstract object orientated (OO) concepts may be suited for communication between highly trained professional developers (who have extensive experience in working with these concepts) but they are not at all suited to a system specification document that will be used to establish common agreement between all stakeholders as to the deliverables of a software system. Because of this, system specification documents that are commonly used in public tenders, for example, generally use diagrams as illustration only and specify their requirements in natural language business process statements and narrative; these documents are accessible to all of the intended audience and can be readily understood by that audience, however, they can also be incomplete and imprecise in the specification of functional requirements.

A useful system specification will typically contain sufficient information for the developers, and other stake holders, to clearly understand what functionality will be provided by the system as well as what it is that they need to deliver that functionality. However, in practice, this objective is seldom achieved and contributes to many of the problems that commonly occur in the development of software systems.

Nevertheless, once a system specification has been finalised, and agreed by all interested parties, the specification is passed to a developer, or development team, who write program source code files to develop a system that complies with the system specification.

The development of the program source code files is typically referred to as “the development phase”. The development phase is frequently the most time-consuming, expensive and error-prone phase of any software system development project.

During the development phase, separate technical design document and program specifications may be created. As a minimum, the development phase will result in the generation of the program source code files. Many methods and tools exist for writing the programs that will execute the specified functionality on specified hardware/software platform(s). However, each method creates a new set of source documentation that has no enforced connection to the agreed system specification.

In addition, unspecified detail is often added during the development phase and requirements are sometimes changed, but not captured in the specification. Thus, over time, the program source code may remain the only reliable documentation. In that event, the system specification becomes a redundant and unreliable reference.

A separate development phase also creates other difficulties.

For example, each developer will test their own programs prior to submission for testing of the whole system. However, the quality of program testing is dependent on the individual developer and almost all systems suffer from low level programming bugs that delay systems testing and successful deployment.

Program source code is notoriously difficult to understand even for the professional developer who originally created the code, making maintenance and enhancement of systems difficult and expensive.

In a disciplined software development process, each element in a project and each change should be documented in the system specification. However, currently this is almost never the case and, unfortunately, system specifications often end up as historical documents that describe what was originally intended rather than providing an accurate current documentation of the running application.

Because of the difficulties described above, it is currently very difficult, if not impossible, for owners/users of computer software systems to retain visibility into the development process and/or retain any real control of their software.

Consequently, a method is needed that provides a single record that is consistent with the running application. In particular, a method is needed that permits all stakeholders access to a single record that is both accurate and understandable and that fully describes the running software system.

### SUMMARY OF THE INVENTION

The present invention generates an executable computer software system directly from a system specification document (hereinafter, “the specification document”) without the need for any programming on the part of the user. Throughout this specification, the “executable computer software system” will be referred to as the “software system”. In this description, a “source file” for a specification document will simply be referred to as the “source file”. In an embodiment of the present invention, the source file for the specification document is used to generate the software system.

Typically, the specification document specifies a required functionality of the software system in a form that is intended to be intuitively understood by system stakeholders.

In one embodiment, the source file for a specification document is in a form that is translatable by a programmed computer to generate a driver-code file. The driver-code file is executable by a run-time engine, resident on a target-platform and compatible with the driver-code, so that the software system is implemented on execution of the driver-code file.

The present invention may obviate the need for a manual programming phase and thus remove, or at least reduce, the problems arising from that phase. In addition, the source file, or a set of source files, for a specification document will typically form a single source for generating the software system. Consequently, the software system cannot be modified independently of the specification document.

Accordingly, the present invention provides a method for implementing a software system on a target-platform, the method including:

preparing a specification document including statements that collectively specify requirements of the software system, the requirement statements expressed with language elements of a specification language, the specification document having an associated source file;

providing the source file to a driver-code generator; and

the driver-code generator translating the source file into a driver-code file, the driver-code file readable by a run-time engine resident on the target platform to provide, at run-time, a software system compliant with the specified requirements.

Throughout this specification, references to the term “target-platform” are to be understood to be references to a computing framework, either in hardware or software or both, for which the software system is targeted. In this respect, a target-platform may include a computer architecture (for example, a computing device), an operating system (for example, Windows), or other software (for example, a JAVA virtual machine) that itself targets an operating system of a target computing device and includes associated runtime libraries.

Throughout this specification, references to the term “driver-code file” are to be understood to be references to a coded sequence that is readable by the run-time engine to enable it to interface with specific hardware and operating system components of the target-platform. In the present case, reading of the driver-code file by the run-time-engine provides a software system compliant with the specification document.

Throughout this specification, references to the term “specification document” are to be understood to be references to a document containing information that defines the functionality of the software system using elements of a specification language. The specification document will typically include a collection of requirements statements, and other elements, that can be printed (or displayed) as a system specification document and that form the basis of an agreed ‘contract’ between the owner/user of the proposed software system and the developer. The functionality is defined using requirement statements expressed as language elements of a specification language, which when translated by the driver-code generator, enable the specified functionality to be deployed and executed on the target-platform, without requiring any computer programming (or a detailed knowledge of complex computer programming languages) on the part of the user. In other words, the driver-code file is generated directly from the specification document, and without generating intermediate programming code, such as a program code for a “commonly used” programming language such as Visual Basic, Java, C# or C/C++.

Thus, in the context of the present invention, a specification document provides dual purposes. First, the specification document provides a mechanism for specifying the functional and environmental requirements of the proposed software system in a form that can be readily accessed and understood by the system stakeholders. Second, the specification document has an associated source file that is translatable to a driver-code file that is generated directly from the source file.

In this respect, a specification language is to be contrasted with conventional computer programming languages. A computer programming language includes a fixed vocabulary (including keywords, function names, types, and variables) that is used to express instructions to a computer. Such instructions are not intuitively understandable by other than a developer having knowledge of that language. A computer program is thus one implementation of a software system that complies with certain requirements, rather than a specification of the requirements themselves.

On the other hand, a specification language includes language elements that specify the requirements of a software system at a higher level than a computer programming language. Thus, a specification document is typically prepared with language elements of a specification language that can be understood to by all stakeholders in the software system and agreed by them. Thus, throughout this specification, references to the term “specification language” are to be understood to be references to a natural language having language elements that are intended to be understandable by all system stakeholders whilst, at the same time, enabling an unambiguous specification of the requirements of a software-system.

A specification language according to the present invention is expected to allow for more flexibility than a computer programming language. Indeed, in one embodiment, the increased flexibility arises from the form of the specification statements which permit requirements statements to be expressed descriptively (for example, using jargon, or industry specific terminology) as opposed to prescriptively.

Thus, the present invention involves the use of a specification language that enables a software system to be specified and executed on a target-platform(s) without any programming on the part of the user, or indeed, without a detailed knowledge of complex computer programming languages.

In an embodiment, the specification language includes plural types of language elements that contribute to the expression of the requirements of the software system, at least in terms of the required functionality, interfaces and data requirements. The types of language elements may include, but need not be limited to, language elements for representing, input/output interfaces, text, numerical elements, data items, data sources, mathematical operators, logical operators, document elements, diagrammatic elements, conditional expressions and picture elements.

A source file may be used to generate a single driver-code file for a single target-platform specified in the specification document. Alternatively, a source file may be used to generate multiple driver-code files so that a separate driver-code file is generated for each specified target-platform. Alternatively, a single source file may be used to generate multiple driver-code files for a single target-platform to permit, for example, the generation of separate driver-code files for different groups of end-users, or applications.

A specification document, and thus a source file, may be prepared using any suitable tool. Preferably, the specification document is prepared using a text file editing tool, in which case, a suitable tool may include a conventional text editor, such as a conventional word processing application. Another suitable tool may include an editing application equipped with customised functionality and services to assist the author(s) of the specification document.

A specification document will typically have a predefined syntax and structure. One suitable structure may include a non-functional requirements section, a functional specification section, and a data access and management section.

The non-functional requirements section preferably includes non-functional requirement statements (for example, requirements statements that express the purpose of the software system, document conventions, project scope, references, overall description, product features summary, design and implementation constraints, assumptions and dependencies).

The functional section preferably includes requirement statements that specify types, arrangements and uses of parameters, and the logical characteristics of each interface between the software system and the users. It is preferred that the functional section include specification statements specifying screen layout constraints, processes and functions. Preferably, the functional section will also specify the design of each user interface provided on implementation of the software system.

The data access and management section preferably includes requirement statements specifying connections between the software system and other specific software components, including databases, tools and libraries.

In one embodiment, the functional section includes plural segments, in which each segment corresponds with a particular user interface design specification, process specification or function specification.

For the purpose of this description, a segment corresponding with a particular user interface design will be referred to as “user interface segment”, whereas a segment that correspond with a process, or a function, will be referred to as “process segment” or a “function segment” respectively. In this respect, references to the term “user interface” throughout this specification are to be understood to be references to an arrangement of components that, on deployment of the software system, provide specific functionality to edit, store, select or display data. By way of example, such components may include buttons, labels, text entry boxes, check boxes, list boxes and radio buttons. On the other hand, references to the term “function segment” are to be understood to be references to a section including requirements statements expressing operations such as mathematical or logical operations.

Preferably, each user interface segment includes an interface design area and function specification area (‘the function area’). In an embodiment, the interface design area includes a simplified graphical and/or textual layout of a user interface design in the form of an arrangement of components, where each component identifies a control for inclusion in the implementation of the user interface layout. In one embodiment, each component has one or more specified properties. Preferably, each component included in a user interface design is identified using a simple notation scheme in which different notations are representative of different component types.

Preferably, the function area contains a listing of expressions relating at least some of the components of a user interface with a required action or event.

In an embodiment, a user interface segment of a specification document also includes a data specification area. Preferably, that area identifies one or more data source(s) having a binding relationship with components included in the interface design area. In an embodiment, the identification of the data source(s) includes providing a reference to a data-structure (such as a database) identified in the data access and management section of the specification document.

If is preferred that a specification document includes a lexicon section defining relationships between complex requirement statements and user-defined statements. A specification that includes a lexicon allows a user to associate a user-selected term with a requirement statement so as to simplify, or clarify, the expression of that statement.

As described previously, in an embodiment, a target-platform includes a specific hardware or operating system that interfaces with the run-time engine so as to provide, on execution of the driver-code file, a software system that complies with requirements contained in the specification document.

In an embodiment where a specification document specifies multiple target-platforms, and the translating of the source file by the driver-code generator includes generating a separate driver-code file for each specified target-platform, each driver-code file is readable by a run-time engine resident on a respective target-platform to provide, at run-time, a software system compliant with the specified requirements.

In one embodiment, each run-time engine includes a first engine (hereinafter referred to as “the interfacing engine”) for accepting the driver-code file generated by the driver-code generator and thereafter translating the driver-code file into intermediate code, and a second engine (hereinafter referred to as the “executing engine”) for executing the intermediate code to provide the software system. One example of a suitable execution engine is a JAVA virtual machine.

An executing engine may include standard libraries of prewritten software and objects, an interface(s) to a database management system, and interfaces to operating system hardware. Preferably, the standardised libraries allow access to other features of the target-platform, such as graphics, threading and networking.

As indicated previously, in one embodiment, the execution of a driver-code file entails the interfacing engine and/or the executing engine translating the driver-code file to the software infrastructure of the target-platform. However, in another embodiment the driver-code file is translated into native code of the target-platform prior to execution. In yet another embodiment, the driver-code is translated by the interfacing engine and/or the executing engine into intermediate code that is then translated into the native code of the target-platform prior to execution

It is preferred that each driver-code file be “locked” to its respective source specification document with a unique matching reference written to both the driver-code file and the source file during the generation process. In this way, the specification document can be matched to the running system via the driver file.

In an embodiment, the source file is also locked as a “read-only file” after allocation of the reference. In this way, the specification document cannot be changed and a new copy of the specification document, and thus the source file, would need to be generated (with a different or no unique reference) for further development.

By generating the driver-code file directly from the source file for the specification document, the manual programming phase of traditional software development is eliminated and the programming errors associated with conventional programming languages can be avoided. In addition, the generation of the driver-code file from the source file for the specification document eliminates the possibility of inconsistencies arising between the required functionality of the computer software system, as specified in the specification document, and the functionality provided by the software system. Such inconsistencies are often encountered in traditional software development approaches as a result of the specification being independent from the software system.

By accepting a source file for a specification document that specifies the target-platform, or target-platforms, the driver-code generator is able generate a driver-code file specific for the specified target-platform(s).

In an embodiment in which the driver-code generator generates a separate driver-code file for each specified target platform, each generated driver-code file corresponds with a specified target-platform so that the driver-code file is readable by the run-time engine of that target-platform to implement a software system compliant with the requirements contained in the specification document.

In an embodiment, the (or each) driver-code file has a format that is understandable by a run-time engine of a specified target-platform. In another embodiment, the driver-code has a format that is more generally understood by the underlying software infrastructure of a targeted computing device (for example, the Common Language Runtime (CLR) for .Net or a Java Virtual Machine (JVM)).

The run-time engine for a target-platform (for example, Windows, PocketPC, Palm, Phone, J2SE, J2EE, J2ME) is capable of reading the driver-code file to thereby implement, on execution, a software system that complies with the specification. In an embodiment, the run-time engine of a target-platform reads the driver-code file and interfaces with underlying software infrastructure installed thereon to drive the executable application of the computer software system. The underlying software infrastructure may include .NET or Java. Thus, the present invention also provides a software system, including:

a run-time engine;

an underlying software architecture interfacing with the run-time engine;

a driver-code file, including a set of coded instructions that are executable by the run-time engine;

wherein the driver-code file has been generated by translating a source file for a specification document including statements that collectively specify requirements of the software system and that are expressed with language elements of a specification language,

and wherein on execution of the driver-code file by the run-time engine, the software system complies with the specified requirements.

A method according to the present invention may further include providing the source file to a specification examiner tool prior to providing an examined source file to the driver-code generator. The specification examiner tool preferably parses the source file and compares language elements contained therein, and the arrangement of those elements, against a specification language corpus and predefined rules, to identify syntactical errors, or omissions, within the source file. It is not essential that such an examination step be performed. However, an examination step may assist in the identification of errors that may otherwise prevent generation of a driver-code file. Thus, the present invention also provides a software development system, including:

a specification editor, operable by a user to produce a specification document including statements that collectively specify requirements of a software system for one or more target-platforms, the requirement statements expressed with language elements of a specification language, the specification document having an associated source file;

a specification examiner tool for parsing the source file and comparing the contents against a predefined set of formalised rules to verify the completeness and correctness of the specification document; and

a generator for translating the source file into a driver-code file for each specified target-platform, each driver-code file being readable by a run-time engine resident on the respective target platform to provide, on execution of the driver-code file by the run-time engine, a software system compliant with the specified requirements.

Another embodiment of a system, or method, in accordance with the present invention further includes providing the driver-code file to a refiner, in the form of a software process or application, that is operable to read and execute the driver-code file and permit a user to select, for display, one more interfaces that will be provided by the software system on execution. Preferably, the user can then manipulate the displayed user-interface to manipulate the design of that user interface. In an embodiment, the manipulation may modify one or more of the position, sizing, colour, font and size of any text elements, and any other adjustments to the appearance of the form that can be referenced in the driver-code file and that have been enabled for modification in the refiner.

After adjustment, the refiner preferably automatically updates the source file for the specification document and/or the driver-code file accordingly. Thus, the present invention also provides a programmed apparatus, including:

a computer readable media containing a driver-code file, the driver-code file including a set of coded instructions generated by translating a source file for a specification document, the specification document including statements that collectively specify requirements of the software system and that are expressed with language elements of a specification language, and a graphical and/or textual layout of one or more graphical user interfaces for user display and interaction;

a processor programmed with computer software for:
executing the driver-code file to provide, at a display output, a representation of one or more of the graphical user interfaces;
allowing a user to manipulate a displayed graphical user interfaces, using an input device, so as to modify visual characteristics of the one or more of the graphical user interfaces; and
updating the driver-code file in accordance with the user manipulation of the one or more of the graphical user interfaces.

The present invention also provides a method of implementing a software system for one or more target-platforms, the method including:

preparing a specification document including statements that collectively specify requirements of the software system, each requirement from an allocation of requirements for each of the one or more target-platforms, the requirement statements expressed with language elements of a specification language, the specification document having a set of associated source files for each of the one or more target-platforms, each set of source files containing information encapsulating requirements allocated to a respective one of the target-platforms;

providing each set of source files to a driver-code generator; and

the driver-code generator translating the respective set of source files into a driver-code file readable by a run-time engine resident on the respective target-platform to provide, on that target-platform, on execution of each driver-code file by a run-time engine, a software system compliant with the specified requirements for that target-platform.

A system and method that uses a refiner is expected to provide further benefits. In particular, a system and method that uses a refiner will allows the specification of user interfaces to focus on the content and basic layout using a simple graphical layout. Thus, a system and method that employs a refiner is expected to reduce the need for a specification writer to be concerned about the component type that will implement each user interface element or the colours, fonts, exact positioning and exact size of each element.

In this respect, although a generator can use a simplified graphical and/or textual layout in the specification to build an appropriate user interface for the run-time environment (for example, Microsoft Windows), at run-time a specified user-interface may be created using default parameters such as, for example, format, colour and font.

During run-time, calculations based on the specification layout may be used to position and size each element of a specified user-interface.

The present invention also provides a programmed computer including:

input interface for accepting a source file for a specification document, the specification document including statements that collectively specify requirements of a software system for a specified target-platform, the requirement statements expressed with language elements of a specification language; and

a processor programmed with computer software for parsing the source file to generate, as an output, a driver-code file for deployment on a run-time engine of the target-platform to provide, on deployment, a computer software system compliant with the computer software system specification.

The present invention also provides a method of implementing a software system on a target-platform, the method including:

preparing a system specification document singularly encapsulating, in a set of requirement statements, the functional and non-functional requirements of the software system, the set of requirement statements including text statements expressed with language elements of a specification language, the specification document having a source file; and

a run-time engine resident on the target-platform generating executable code directly from the source file, the executable code being executable by the run-time engine to implement the software system such that the implemented software system complies with the specified functional requirements, and wherein the software system is generated without the generation of intermediate code containing computer program instructions in the form of a programming language.

A particular advantage of the present invention include that it provides a single documentation source that is consistent with the running application.

It is envisaged that the present invention will enable faster development and maintenance of software systems, leading to significant cost reductions, a closer match of software systems to business needs, ownership of computer software systems by the business and consistent performance, security, reliability and scalability.

### BRIEF DESCRIPTION OF THE DRAWINGS

The present invention will now be described in relation to various embodiments illustrated in the accompanying drawings. However, it must be appreciated that the following description is not to limit the generality of the above description. In the drawings:

FIG. 1 is a schematic diagram illustrating the high-level architecture of a system for implementing a software system in accordance with an embodiment of the present invention;

FIG. 2 is a system block diagram illustrating the data flow between the objects of the system of FIG. 1;

FIG. 3 is an example structure of an underlying architecture a target-platform for use in implementing a software system defined by a specification in accordance with an embodiment of the present invention;

FIG. 4 is an example structure of a specification document in accordance with an embodiment of the present invention;

FIG. 5 is a structural diagram showing, at a lower level, an example structure of a non-functional requirements section of a specification document in accordance with an embodiment of the present invention;

FIG. 6 is a structural diagram showing, at a lower level, an example structure of a functional requirements section of a specification document in accordance with an embodiment of the present invention;

FIG. 7 is a structural diagram showing, at a lower level, an example structure of a data storage and access section of a specification document in accordance with an embodiment of the present invention;

FIG. 8 is an example of a user interface segment of a specification document in accordance with an embodiment of the present invention;

FIG. 9 is another example of a user interface segment of a specification document in accordance with an embodiment of the present invention;

FIG. 10 is an example of a process segment of a specification document in accordance with an embodiment of the present invention;

FIG. 11 is an example of a function segment of a specification document in accordance with an embodiment of the present invention;

FIG. 12 is an another example of a function segment of a specification document in accordance with an embodiment of the present invention;

FIG. 13A is an example of a data storage and access section of a specification document in accordance with an embodiment of the present invention;

FIG. 13B is another example of a data storage and access section of a specification document in accordance with an embodiment of the present invention;

FIG. 13C is an example of a data storage and access section of a specification document in accordance with an embodiment of the present invention;

FIG. 14 is a system block diagram of a system in accordance with a second embodiment of the present invention;

FIG. 15 is a system block diagram of a system in accordance with a third embodiment of the present invention;

FIG. 16 is a system block diagram of a system in accordance with a fourth embodiment of the present invention for generating multiple driver-code files for multiple target-platforms; and

FIG. 17 is an example structure of a lexicon section of a specification document in accordance with an embodiment of the present invention.

### DETAILED DESCRIPTION OF THE DRAWINGS

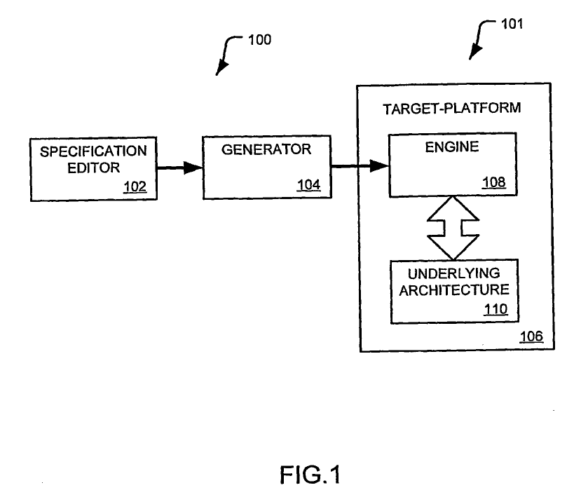

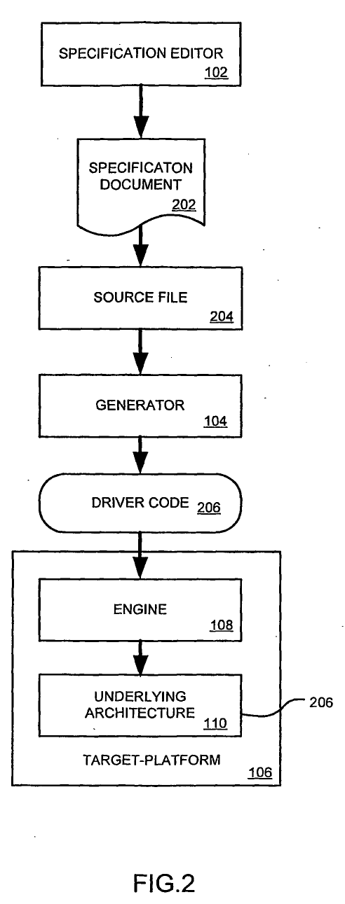

FIG. 1 illustrates a system 100 according to an embodiment of the present invention for generating a software system 101 compliant with requirements specified in a specification document 202 (ref. FIG. 2). The system 100 includes a specification editor 102 and a generator 104.

The specification editor 102 is typically a text editor, or a word processor, that is operable by a user to prepare a specification document 202 (ref. FIG. 2) having an associated source file 204 (ref. FIG. 2) that is translatable to generate the software system 101.

The specification document 202 (ref. FIG. 2) includes statements that collectively specify requirements of a software system 101 that is implementable on a target-platform 106. The statements are expressed with language elements of a specification language to thereby obviate the need for any programming on the part of the user.

As shown in FIG. 2, once created, the source file 204 for the specification document 202 is input into the generator 104 to translate the source file 204 into a driver-code file 206. The driver-code file 206 is readable by a run-time engine 108 resident on the target platform 106 to provide, at run-time, a software system 101 that utilises at least some of the resources of an underlying architecture 110. The implemented software system 101 is compliant with the requirements specified in the specification document 202.

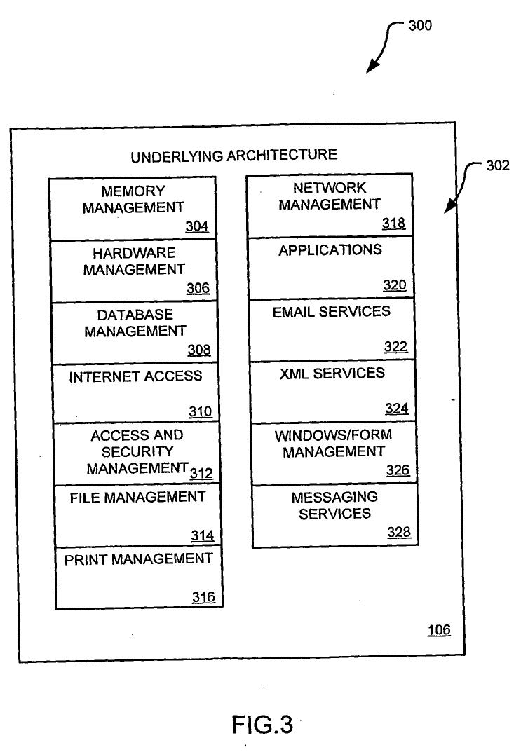

An example of an underlying architecture is shown in FIG. 3. That example includes a range of resources 302, including memory management resources 304, hardware management resources 306, database management resources 308, internet access resources 310, access and security management resources 312, file management resources 314, print management resources 316, network management services 318, applications 320, email services 322, XML resources 324, windows management resources 326, and messaging resources 328. The function and capabilities of these resources would be well understood to a skilled software developer.

The run-time engine 108 reads a driver-code file 206 and delivers the functionality through the resident underlying infrastructure 110 (typically .Net or a JVM) on the computing-device of the target-platform 106. Thus, each target-platform 106 includes an engine 108.

The run-time engine 108 will typically be a program created solely to process driver-code files 204. However, in other embodiments, the run-time engine 108 could be a general purpose engine like Microsoft's Common Language Run-time (CLR) for .Net. Significantly, a single run-time engine 108 may run multiple driver-code files 206 to thereby implement multiple software systems on the same target-platform 106.

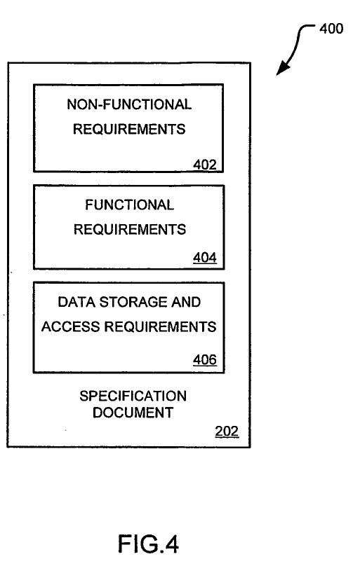

A specification document 202 is prepared using a specification language and includes a structure that allows a user to completely and unambiguously specify the requirements of the software system 101. One example of a suitable structure 400 is illustrated in FIG. 4.

The specification language of the present invention is a language including elements that are intended to be intuitively understood by different system stakeholders and that allows for some flexibility in the language. For example, a requirement statement may be expressed using keywords or phrases (that is, words or phrases that form part of the specification language) supplemented with non-keywords. Such non-keywords may assist a reader in the understanding of a requirement statement, but not alter the resultant functional implementation. Thus, a single requirement statement may include keywords, and additional words arranged in conjunction therewith, provided that a key word(s) or phrase(s) is present in that statement. Table 1 provides an example of a requirements statement including a keyword, and an example of a statement including a key phrase:

TABLE 1

| | Equivalent Requirement Statement | |
|---|---|---|
| Key Word/Key Phrase | Expression | Description |
| Return | ‘Return to previous form’ | |
| | ‘Return to the order summary’ | |
| ‘for Customer and Order’ | ‘for this Customer and Order’ | The key phrase includes the key |
| | ‘for the current customer and this new | words ‘Customer’ and ‘Order’. |
| | order’ | ‘Customer’ and ‘Order’ are table |
| | ‘for the selected Customer and Order’ | names in a data section of a |
| | | specification document and may be |
| | | used in the specification language |
| | | without further explanation |

In the above examples, the driver-code file generator 104 recognises the keyword components of the requirement statements and thus understands the context of the statement.

With reference to FIG. 4, a preferred structure 400 of a specification document 202 includes a section 402 encapsulating non-functional requirement statements, a section 404 encapsulating functional requirements requirement statements 404 and a data section 406 (hereinafter the ‘data storage and access section’) encapsulating data storage and access requirement statements.

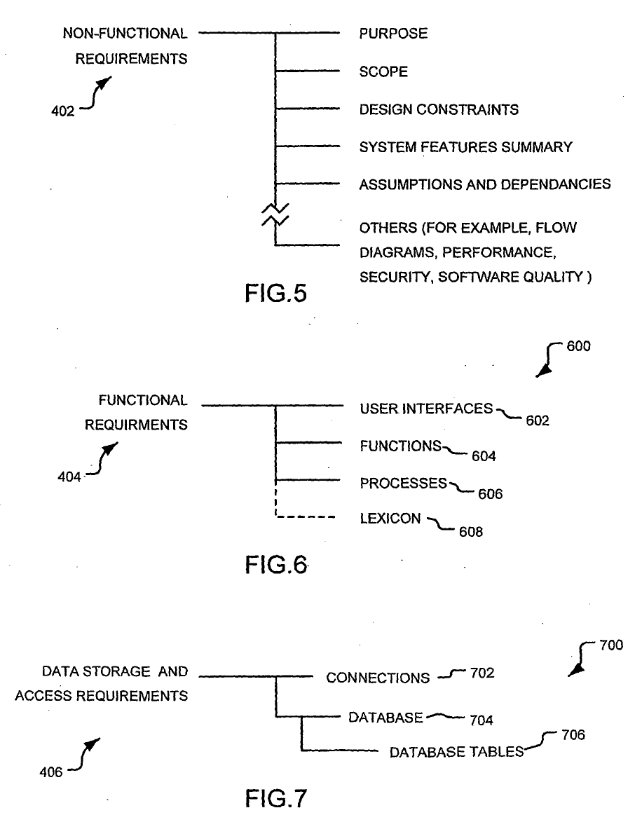

As shown in FIG. 5, the section 402 encapsulating non-functional requirement statements will typically include requirement statements that specify non-functional characteristics of the software system 101. Non-functional requirements statements are important in forming an agreed basis for implementing the software system 101. Examples, of types of non-functional requirement statements that may be included in section 402 include statements that specify the scope of the system, design constraints, system features, assumptions and dependencies and the like. It will be appreciated that the types of non-functional requirement statements items identified in FIG. 5 are non-limiting examples. Thus, a section 402 may include non-functional requirement statements expressing other non-functional characteristics of a software system 101 beyond those identified in FIG. 5.

An example structure 600 of a section 404 encapsulating functional requirements statements is illustrated in FIG. 6. As shown, the section 404 includes requirements statements specifying characteristics of functional elements of the software system 101 including, user interfaces 602, functions 604 and processes 606. The section 404 may also include a lexicon 608 including statements specifying relationships between user-defined statements and requirement statements of increased complexity. An example of a lexicon is provided later in the specification.

In one embodiment, a section 404 encapsulating functional requirements includes three types of specification segments, namely, a user interface segment, a function segment and a process segment. The structure and role of each of these segments will be described in more detail later.

An example structure 700 of a section 406 encapsulating data storage and access requirement statements is illustrated in FIG. 7. As shown, the section 406 includes requirement statements specifying connections 702 between the software system 101 and other specific software components (name and version) including databases 704. For each specified connection 702 with a database 704, the section 406 will also include requirement statements specifying database tables 706 of each database 704 that are to be accessed by the software system 101. For each database table, section 406 will include indexes indexing data items of the database table 706.

Returning now to the section 404 including requirements statements specifying characteristics of functional elements of the software system 101, and as is shown in FIG. 6, that section 404 will typically include a separate segment for each specified functional module. Thus, a section 404 may include a segment for each specified user interface 602 (hereinafter, ‘a user interface segment’), each specified function 604 (hereinafter, ‘a function segment’) and each specified process 606 (hereinafter, ‘a process segment’). Each of these segments will now be described in more detail.

User Interface Segment

For each specified user interface 602, each user interface segment provides a layout of a user interface that will be generated when the software system 101 is implemented. Each layout of a user interface may include a simplified graphical (for example, a diagrammatic representation) and/or textual layout of a graphical user interface (GUI) for user display and interaction (for example, on a computer display).

In addition to providing a simplified layout of a user interface, each user interface segment may also specify events linked to activation of layout components in the user interface segment as well as relationships between components of the user interface and data sources (specified in the data storage and access section) 406 (ref. FIG. 7), processes 606 and functions 605.

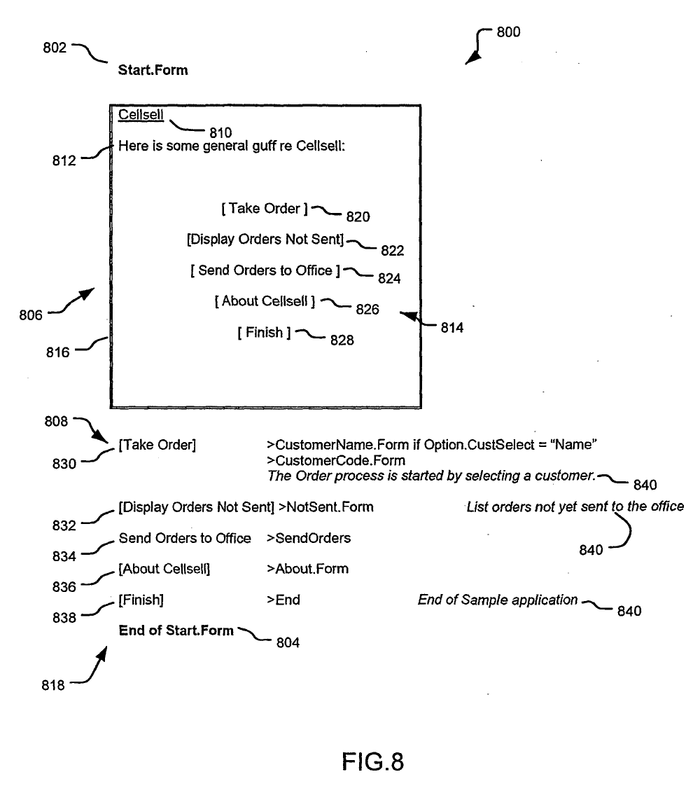

A simple example of a user interface segment 800 that specifies a user interface is shown in FIG. 8. The segment 800 includes a start identifier 802, an end identifier 804, and two areas therebetween, namely, an interface design area 806 and a function area 808.

The illustrated interface design area 806 provides a simplified diagrammatic and textual layout of a GUI. On the other hand, the function area 808 includes statements specifying support processes and events and may also include comments 840 that provide further assistance the reader.

The start 802 and end identifier 804 are used to identify the boundary of the user interface segment 800 and, as will be explained in more detail later, are used by the driver-code generator 104 (ref. FIG. 1) in the production of a driver-code file 206 (ref. FIG. 2). The start identifier 802 also provides a unique identifier for the user interface segment 800.

The interface design area 806 includes an arrangement of components 810, 812, 814, 816. In the present case, each component 810, 812, 814, 816 provides a simplified representation of an element that will be included in the resultant user interface (in this case, the GUI that will be displayed on implementation of the software system 101). As will be explained later, an interface design area 806 may include various types of components representing, for example, various types of controls. Indeed, each component may provide a simplified representation of a control, such as such as command buttons, text boxes, and the like.

Different components may be provided for different user interfaces, depending, for example, on the intended purpose or function of the user interface.

In the example illustrated in FIG. 8, the components includes a “box” component 816 (representing a “form” object of the resultant GUI) and “control” components 814 (in this case, representing “command buttons” controls in the resultant GUI).

It is not essential that a user interface segment include a box component 816. However, it is preferred that a box component 816 be provided since it will provide, to the user, an indication of the size of the user interface display on the target-platform 106.

The range and type of controls that are representable using components in the interface design area 806 will depend upon the software-environment of the target-platform 106. For example, for a target-platform deploying a Microsoft Windows software environment, the range and type of controls may include some, or all, of a set of controls that are provided with that environment including, for example, command buttons, radio buttons, group boxes, scroll bars, timers, text boxes, list boxes, picture boxes, tracker bars and check boxes. In an alternative environment, such as Java, different controls may be available and thus represented in an interface design area 806.

A control may be represented by a control component using any suitable notation. However, it is preferred that the notation be sufficiently simple to allow creation of control components using a text editor.

In the example illustrated in FIG. 8, the control components 814 representing command buttons are represented using a notation consisting of a label (in the form of a text label) identifying a text attribute of the respective command button, enclosed within square brackets. It will be understood that other types of controls may also be represented using a similar notation scheme. For example, table 2 identifies other example notation schemes for a selection of other control components:

TABLE 2

| Component | Component Notation | Description |
|---|---|---|
| Label | Name | Labels can be any text beginning with a |
| | | capital letter or ending with “:”. They |
| | | will display exactly as typed. |
| Text Box | X---Name-------X | “Name” is name of text box |
| | XXXX | 4 characters, usually preceded by a |
| | | Label. |
| | 99999.99 | Formatted numeric text box. |
| | dd/mm/yyyy | Formatted date text box. |
| | dd/mm/yyyy . . . | Formatted date with date-picker |
| ComboBox | X---Name------X\hat{ } | Combo box allowing data entry and picklist |
| Multi-Line | #------------------# | Textbox, displaying three lines |
| TextBox | #----Notes-------# | |
| | #------------------# | |
| Picture Box | #--------------# | Space available to display a picture or |
| | # # | bitmap. |
| | # Face # | |
| | # # | |
| | #--------------# | |
| Button | [Button Name] | Command button labelled as “Button Name” |
| CheckBox | [x] | |
| Radio Buttons | [.] Black | Allows choice of one option |
| | [.] White | ″ |
| | [.] Grey | ″ |
| | [:] Black | Allows choice of multiple options |
| | [:] White | ″ |
| | [:]Grey | ″ |
| Progress Bar | [Progress . . . ] | |
| ListBox | !---Name-----! | “Name” denotes item to be listed |
| DataGrid | !-Item1-!!-Item2-! . . . | As many columns as required |
| End of list | !End! | Denotes bottom of ListBox or DataGrid. |

Still referring to FIG. 8, the function area 808 includes requirements statements 818 specifying supporting events (for example, functions, processes and calculations) linked to the activation, in the implemented software system 101, of event-activating components 814 specified in the interface design area 806. Thus, for each event-activating component 820, 822, 824, 826, 828, the function area 808 includes an associated requirement statement 830, 832, 834, 836, 838 specifying the activatable event.

Again, in the example illustrated in FIG. 8, the components 814 represent “command buttons”. Thus, each component 820, 822, 824, 826, 828 has an associated requirement statement 830, 832, 834, 836, 838 in the function area 808 specifying an event that is activated on operation of a respective “button” 814. For example, requirement statements 830, 832, 834, 836 each specify that another user interface is to be loaded and displayed on activation of a respective button 820, 822, 824, 826. For example, statement 832 specifies that a user interface, specified using a user interface segment identified as “NotSent.Form”, be loaded and displayed in response to the activation of button 822 (“[Display Orders Not Sent]”).

The requirement statements contained in the function area 808 may be specified conditionally or unconditionally. By way of example, statement 830 is specified as a conditional statement since, on implementation of the software system 101, either the user interface specified by the segment identified as “CustomerName.Form” or the user interface specified by the segment identified as “CustomerCode.Form” will be selected and displayed on activation of the button 820. The statement 830 is conditional because the next user interface for display is selected based on the state of the “Name” data item.

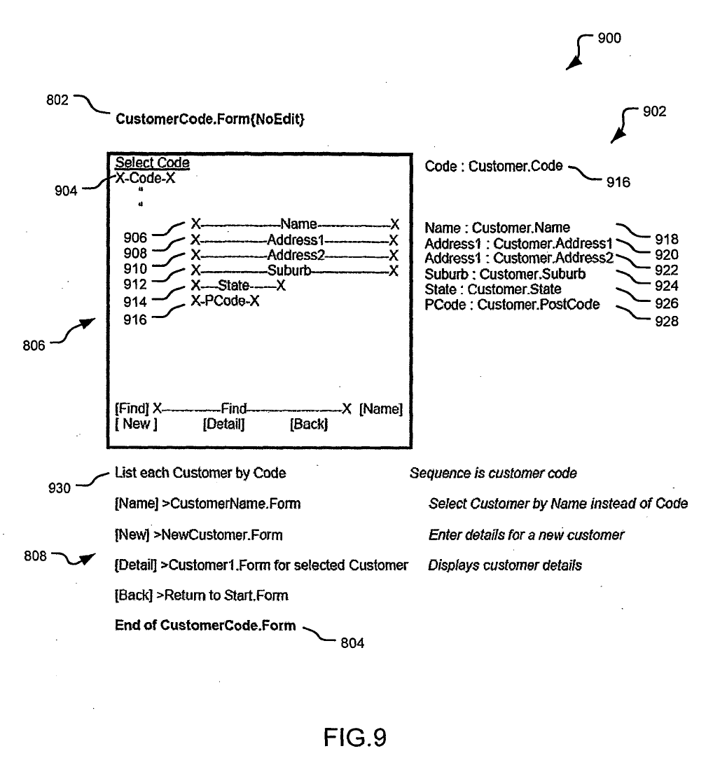

Another example of a user interface segment 900 of a specification document is illustrated in FIG. 9. The user interface segment 900 also includes a start identifier 802, an end identifier 804, an interface design area 806 and a function area 808. However, the user interface segment 900 further includes a data specification area 902, separate from the interface design area 806 and the function area 808. In addition, the user interface segment 900 also includes control components 904, 906, 908, 910, 912, 914 representing controls (for example, a text box) for displaying data items retrieved from a data source identified by corresponding requirements statements 916, 918, 920, 922, 926, 928 of the data specification area 902.

The function of the data specification area 902 will now be described in more detail.

The data specification area 902 includes requirement statements that specify a binding between a data source and a component in the interface design area 806 that specifies a data item. Thus, each specification of a data source binds a data source with to a respective data item of a component identified in the interface design area 806.

Each component in the interface design area 806 having an associated data item is bound to a data source (specified in the data specification area 902) in a simple and intuitive way.

Associating a data item with a component may be by inference, perhaps from a preceding label, as is evident from the example included in Table 3:

TABLE 3

| Control Component | Notation |
|---|---|
| “Customer Name: X-----------------X” | X-----------------X” indicates position and length |
| | attributes of the control component containing the |
| | data item identified as “Customer Name” |

Alternatively, an association can be labelled explicitly, such as the example in Table 4.

TABLE 4

| Control Component | Notation |
|---|---|
| “X-----Customer Name-------X” | Indicates position and length attributes of the control |
| | component containing the data item identified as |
| | “Customer Name” |

The binding of a data source to a data item is then specified, in the data specification area 902 as, for example:
“Customer Name: Customer.Name”

In which case, “Customer.Name” represents a “Name” ‘column’ in a database table called “Customer”. An entire data requirement can be specified from this simple process.

A user interface segment that includes an interface design area 806, a data specification area 902, and a function area 808 may have any suitable arrangement. However, an arrangement that allows a reader to readily comprehend the relationship between data items and data sources is preferred. Thus, in the example illustrated in FIG. 9, the interface segment 900 is arranged so that the statements 916, 918, 920, 922, 924, 926, 928 that specify a data source and the respective statements of the interface design area 806 specifying components having an associated data item are adjacently arranged.

As described above, the content and arrangement of each user interface segment specifies the data requirements and thus defines the meaning and data source for each data item (and any supporting processes and calculations included) within that segment.

It is to be appreciated that although this description describes examples of interface segments as “forms”, the invention is not to be so limited. Indeed, other embodiments of the present invention may include a specification(s) file(s) containing user interface segments that provide simplified layouts of reports, documents, messaging formats (for example, an email message format), document templates, web-pages, or other input/output interfaces, for printing or displayed on a display connected to the computer system implementing the software system 101, or remotely.

Process Segment

Each process segment specifies a program process that will be executable when the software system 101 is implemented. Accordingly, each process segment includes requirement statements specifying an action, or sequence of actions, that will be executable on implementation of the software system 101. However, each process segment is written using a specification language so as to obviate the need for any programming on the part of the user.

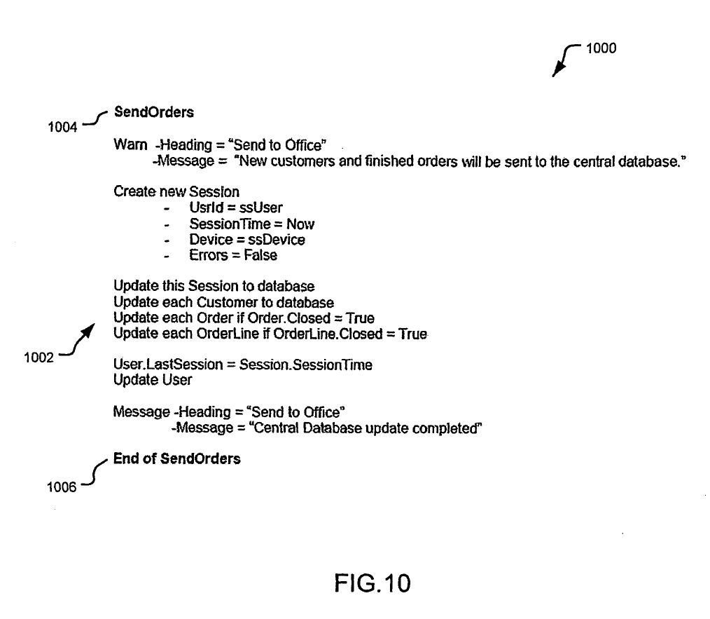

One example of a process segment 1000 is illustrated in FIG. 10. The process segment 1000 includes specification statements 1002 specifying a process identified as “SendOrders”. The process 1002 is bounded by a start identifier 1004 and an end identifier 1006. The start identifier identifies the name (in this case, “SendOrders”) of the process segment 1002.

On execution of the process specified by the process segment 1002, the process will provide a warning message to a user prior to creating a new session row in a database table named “Session”. In this example, the process will then update the database table named “Session”, and five other database tables (that is, the Customer table, the Order table, the Oderline table and the User table).

Function Segment

Each function segment encapsulates a program function that will be executable on implementation of the software system 101. Thus, each function segment includes specification statements, in the form of functional specification statements, specifying, for example, an assignment, a calculation or a logical operation.

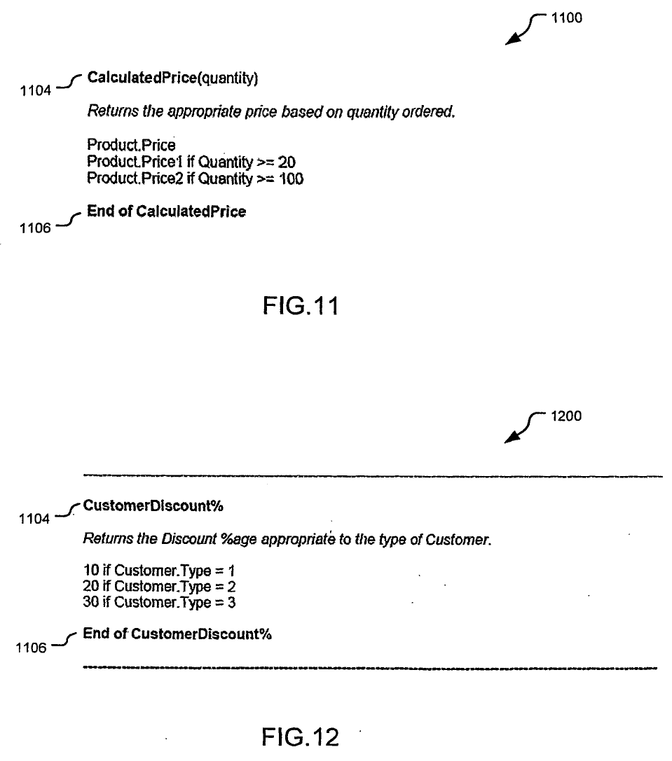

FIG. 11 shows a simple example of a function segment 1100 of a specification document 202. The function segment 1100 includes a start identifier statement 1104 specifying the name (in this case, “CalculatedPrice”) of the function segment 1100 and the type of parameter (in this case, “quantity”) that is passed to the segment 1100 from a segment that calls the function 1100.

The name of the function segment is that property which is used, by other segments, to specify the function segment. An end statement 1106 terminates the function segment 1100.

With reference to the example function segment shown in FIG. 11, the function segment 1100 includes specification statements for a function that, when implemented, will return a value for the “CalculatedPrice” function that depends on value of the parameter “Quantity”. In particular, if the “Quantity” value is less than twenty, the “CalculatedPrice” function will retrieve a “Product.Price” value from the “Product” database table, as identified in the data storage and access section 406 (ref. FIG. 7) of the specification, and return as the result of the “CalculatedPrice”. Alternatively, if the “Quantity” value is greater than, or equal to twenty, but less than one-hundred, the “CalculatedPrice” function will retrieve a “Product.Price1” value from the “Product” database table and return that value as the result of the “CalculatedPrice” function.

Finally, if the “Quantity” value is greater than, or equal to, to one-hundred, the “CalculatedPrice” function will retrieve a “Product.Price2” value from the “Product” database table and return that value as the result of the “CalculatedPrice” function.

Another example of a function segment 1200 is shown in FIG. 12. The function segment 1200 returns a “CustomerDiscount %” result that depends on a value of “Customer.Type” retrieved from the “Customer” data base table identified in the data storage and access section 406 (ref. FIG. 7) of the specification.

In each example, the function segments 1100, 1200 include specification statements that specify functions that are executable by the software system 101 on implementation. Each function module 1100, 1200 is prepared without any programming on the part of the user.

Data Storage and Access Section

Having described example structures of the segments that specify functional requirements, the description will now turn to the data storage and access (DSA) section 406 (ref. FIG. 7) of the specification document.

A DSA section 406 of a specification document encapsulates all of the data requirements of a software system for a target-platform. Thus, a DSA section 406 provides within the specification document, a single reference point that formally specifies all external data sources for data items specified in other segments of the specification document.

In one embodiment, the data requirements are specified using a set of specification statements that collectively specify the physical source of the data, security rules and connection requirements.

A DSA section 406 may be “built” manually (for example, by a user entering DSA section 406 specification statements using a text editor), or it may be automatically generated using a suitable tool.

An automatic generation process is preferred and may entail a computer application parsing the source file 204 for the specification document 202 to identify all specification statements including a data item that is bound to a data source, and thereafter automatically creating a DSA section 406 containing a collection of data source statements that binds each data source statement to a physical data source. In either case, a DSA section 406 can be prepared without the need for any programming on the part of the user.

A DSA section 406 may include plural types of specification statements. At the least, it will include statements that specify a database management system (DBMS), a database connection, a database table for each specified database, and indexes (in the form of data element names) into each specified database table. A DSA section 406 may also include specification statements (for example, an SQL statement select command) where a subset of data from a specified database table is required.

Each DBMS specification statement identifies the type database management system (DBMS) for controlling storage, modification and retrieval of information from a specified database table. In this respect, a DSA section 406 may specify a single DBMS type (for example, Microsoft's SQL Server), or it may specify plural DBMS types. For example, a single specification may include DBMS specification statements that specify an SQL Server, Oracle, DB2, or Access DBMS type. Each specified DBMS could enable access to one or more databases that are specified by the specification. An embodiment that includes multiple databases will include plural specification statements identifying a relationship between a specified database table and one of the specified databases.

A database connection statement contains information required to connect the implemented software system 101 to a specified database. Thus, a connection specification statement may include a user's identification and password information. In an embodiment of the present invention that accesses multiple databases, a separate connection statement will be provided for each specified database. For example:

DBMS: Sql Server
Database: CellsellSQL
Connection String Data Source=ABC; User ID=JSmith; Password=123XYZ; Initial Catalog=CellSellSQL
Database: FiveYearHistory
Connection String Data Source=Data Source=ABC; User ID=JSmith; Password=123XYZ; Initial Catalog=FiveYearHistory

Where:
“DBMS: Sql Server” is a specification statement specifying the DBMS type as a Microsoft® SQL Server;
“Database CellsellSQL” is a specification statement specifying a first database named “CellSellSQL”
“Connection String: Data Source=ABC; User ID=JSmith; Password=123XYZ; Initial Catalog=CellSellSQL” is specification statement specifying connection information for accessing the first database;
“Database: FiveYearHistory” is a specification statement specifying a first database named “FiveYearHistory”;
“Connection String: Data Source=Data Source=ABC; User ID=JSmith; Password=123XYZ; Initial Catalog=FiveYearHistory” is specification statement specifying connection information for accessing the first database.

For each specified database, the database table statements specify database table information for that database. Each database table may be specified using table names that are readily understood by the system specification stakeholders. However, the actual data may be stored in database tables with different and less intuitive names. Advantageously, the specification allows for that by having a suitably qualified technical expert supply the equivalent physical database names for the DSA section 406 of the specification document. A specification document may include one or more database tables for each specified DBMS.

For each specified database table, the DBMS provides a listing of data items that are required, from that table, by the software system 101. For each data item, the DMBS may also provide an associated identifier that assists a reader in identifying the data type of each data item indexed in a database as shown, by way an example, in Table 5:

TABLE 5

| Identifier | Data Type |
|---|---|
| N | numeric type; |
| X | alphanumeric type; |
| D | data type; |
| T | true/false type; |
| M | memo type (that is, multi-line text); |
| B | bitmap type; |
| V | video type; |
| A | audio type; |
| L | link type; |
| P | PDF file type. |

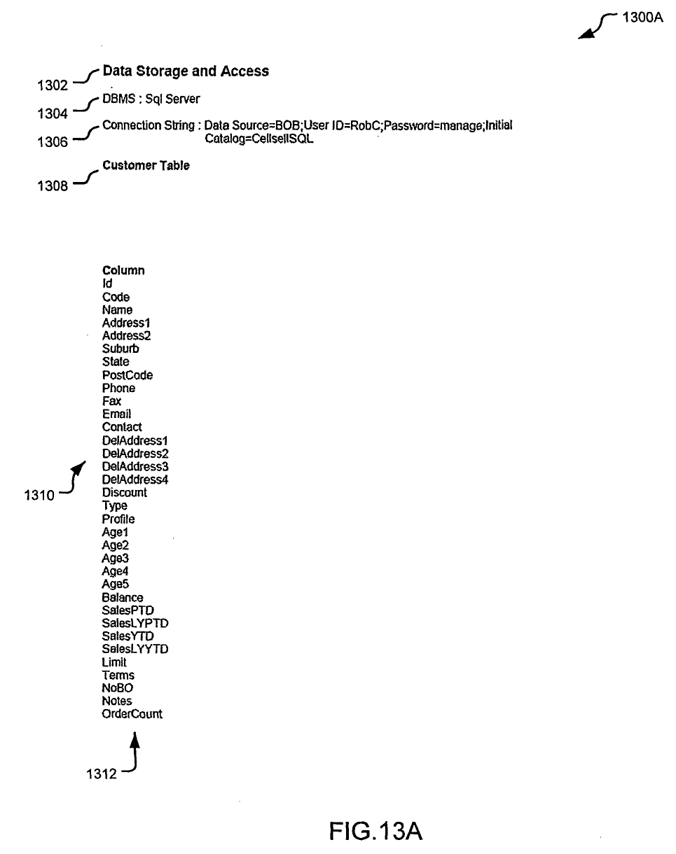

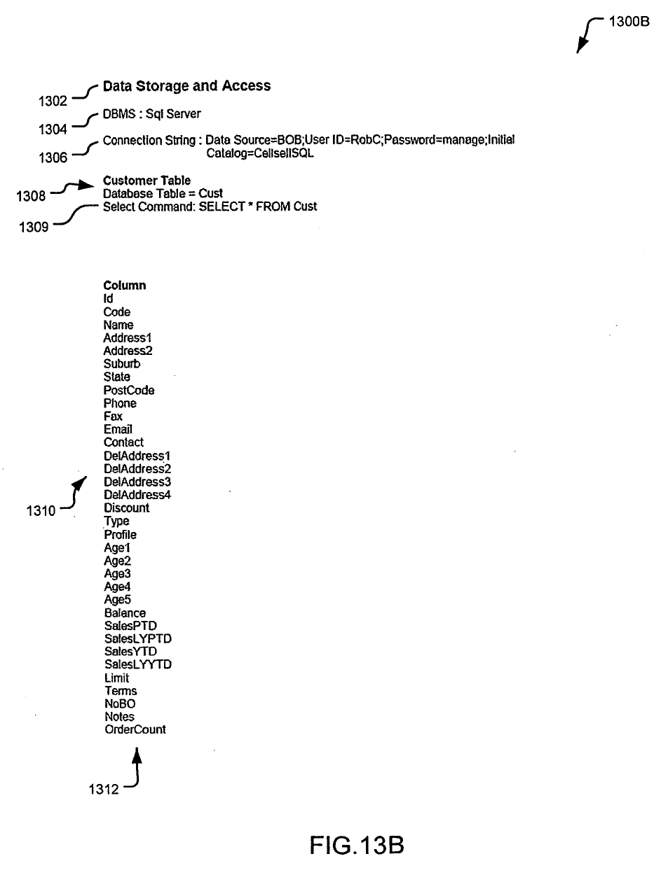

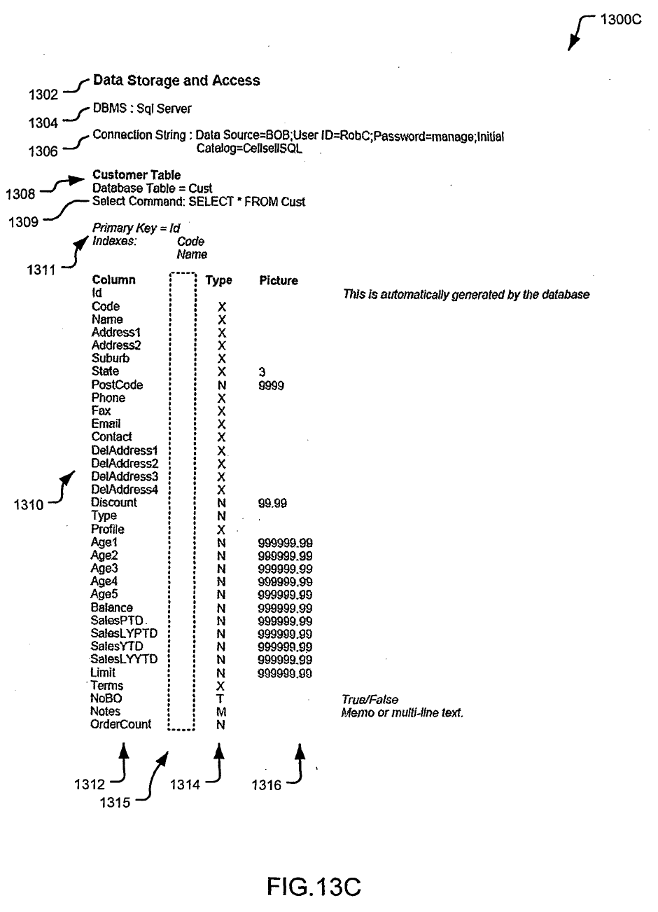

FIG. 13A provides an example structure 1300A of a DSA section 406. The example DSA section 1300A includes a header statement 1302 identifying the start of the DSA section 1300A. The exemplary DSA section 1300A also includes a DBMS type statement 1304 identifying the DBMS as “SQL Server”.

Database connection statement 1306 specifies connection information required to connect the software system 101 to a database identified as “CellSellSQL”. The DBMS statement 1304 and database connection statement 1306 items apply to a particular DBMS and not each database table, thus plural database tables could exist under one DBMS.

Statement 1308 identifies the data-source identifier used to reference the database table throughout the specification document (in this case, “Customer Table”). Statement 1308 is an example of a SELECT statement what would ordinarily be used where a subset of data from a specified database table is required.

Column 1312 includes identifies indexes 1310 into the database table. In the present case, the index names 1310 match the physical database names and the system inherits the data types, length, format and the like from the database.

FIG. 13B provides another example structure 1300B of a DSA section 406. The example DSA section 1300B also includes a header statement 1302 identifying the start of the DSA section 1300B. The exemplary DSA section 1300B also includes a DBMS type statement 1304 identifying the DBMS as “SQL Server”.

The DSA section 1300B also includes a database connection statement 1306 specifying connection information required to connect the software system 101 to a database identified as “CellSellSQL”. However, in this case the names used throughout the specification document are different to the name of the physical database so the DSA section 1300B includes a statement 1308 relating the name used (that is, “Customer”) in the preceding sections of the specification document to the name of the database table to be accessed (in this case, “Cust”). Again, in the present example a SELECT statement 1309 has been included for example purposes. Ordinarily, a SELECT statement would be used where a subset of data from a specified database table is required.

FIG. 13C provides yet another example structure 1300C of a DSA section 406. This example DSA section 1300C also includes a header statement 1302 identifying the start of the DSA section 1300C. The DSA section 1300C also includes a DBMS type statement 1304 identifying the DBMS as “SQL Server”. However, DSA section 1300C further includes columns 1314, 1315 (shown dashed), 1316 for information purposes. The columns 1314, 1316 include entries for respectively identifying data item types and formats of the data indexed by the index names 1310. As shown, DSA section 1300C may also include a further column 1315 including entries for associating a data item index in column 1312 with the name of a physical database column name, where those names are different. For example, in the present example, a column 1318 is also provided for comments (in italics) that may assist the reader in understanding the organisation of the database table.

The data item type column 1314 includes, for each index, a coded entry that specifies a data item type, using the notation described earlier.

The data element format column 1316 includes, for each index, a coded entry that specifies the format, length, or mask for each indexed data element. In the present case the specified format is deduced from format notation information included with data item references specified in the functional requirement specification section. For example, where a data item has been specified as an alphanumeric item “XXXX” will denote a character length of four. In this respect, an alphanumeric data item may also be specified as “X----X”, where “X----X” denotes a character field of variable length for data storage (in this case it will generally assume the physical database column length, however, the space used in the layout may be used to calculate the size of a GUI control to hold the data on the user interface). In relation to an example of a numerical data item, “9999” denotes a character length of four. The data element type column 1314 and the data element format column 1316 are optional.

The example DSA section 1300C also includes statements 1311 specifying a primary key and other keys (in illustrated example, “Code” and “Name”) into the specified database table. It is not essential that statements 1311 be provided. However, the inclusion of statements 1311 may assist the reader in understanding the organisation of the database.

Having described a preferred structure of a specification document format for use with the present invention, the description will now turn to the generation of the driver-code file by the generator 104.

Driver-Code Generation

A specification document prepared according to the present invention should be complete and unambiguous in order to generate a driver-code file 206. This requirement is, in itself, a significant one benefit because it will increase the likelihood of a software system being properly specified and agreed at system specification time; it is not left to a separate development team to design input/output content and format, or decide where to source the data from (for example, which price field to display or how to calculate the discount), or impose their view of how a business process should be implemented. Therefore, an embodiment of the present invention supports the creation of a high quality system specification for a software system that cannot be implemented without a complete system specification.

Referring again to FIG. 1, in the present case, the generator 104 is a computer program written for the purpose of interpreting the source file 204 of the specification document 202 and translating the source file 204 into one or more driver-code files 204.

Each driver-code file 206 is for subsequent execution by an engine 108 resident on a target-platform 106 to deliver the specified functionality on that platform.

A generator 104 uses the source file 204 of a specification document 202 as an input and provides, as an output, driver-code file(s) 206 that are executable by an run-time engine 108 resident on a specified target-platform to implement a software system 101 compliant with the specification document 202.

Each generated driver-code file 206 may be linked to its source file 204 with a unique matching reference that is written to both files (that is, the source file 204 and the driver-code file 206) during the generation process so that the source file 204 can be matched, and thus locked to, a running system via the driver-code file 206.

It is also preferred that the source file 204 of a specification document 202 is also locked as a “read only” file after a matching reference has been allocated, so that the specification document 202 cannot be changed after a driver-code file 206 has been generated. Thus, further development would require a separate copy (for example, a further issue) of the specification document 202 to be made (with a different or no unique matching reference).

The operation of the generator 104 will depend upon the type and format of the source file 204. In an embodiment of the present invention in which the source file 204 has been prepared as a Microsoft WORD document, the first step in the generation process converts the source file 204 to plain text to prepare a compact work file. In such an embodiment, the generator 104 may perform the following sequence of events:
(a) Convert the source file 204 to plain text (this is an optional step since the word processor (for example, Microsoft Word) and/or target software infrastructure will usually provide a standard function to do this;
(b) Remove all sections of the source file 204 not required—the generator 104 only needs to work with the “System name”, the functional section 404 and the DSA section 406;
(c) Remove all explanatory comments;
(d) Remove any remaining formatting characters and ‘white space’ from the source file 204 except when inside any user interface segment; and
(e) Replace specification line continuation characters with a space.

In an embodiment, the generator 104 uses the “System: statement” in the source file 204 as the name of the software system 101 and then looks for a “Host:” (or equivalent) specification statement to begin building a driver-code file 206 for the specified target-platform 106.

Each “Host:” statement will typically have a matching “End Host:” statement; the generator 104 will generate a driver-code file 206 based on the specification text between these statements.

In an embodiment, there may be multiple “Host:” statements, in which case multiple driver-code files 204 may be generated from a single source file 204. Typically though, there will be a separate driver-code file for each target-platform 106. However, there may be additional considerations that lead to multiple driver-code files 204 being generated for the same target-platform 106 (for example, the generator could allow generation of separate drivers for different groups of end-users).

A suitable procedure for implementation by a generator 104 to generate a driver-code file 206 is as follows.
(a) Check for a valid target-platform and write a target code to the driver-code file 206;
(b) Check for a valid database management system(s) by looking for a DBMS statement in the DSA section 406 of the source file 204 before writing the relevant code(s) and associated connection string(s) to the driver-code file 206.
(c) Pass through the source file 204 and build a unique reference for each segment; and
(d) Build reference tables for all database tables specified in the DSA section 406 and all items in the lexicon section.

The source file 204 can then be processed sequentially by the generator 104, and within the host-platform boundaries, to generate the driver-code file 206 for each segment in the source file 204.

For each user interface segment 602, the user interface generated for execution at run-time can be inferred by the specification format ‘drawn’ in text.

Generally, the run-time user interface will assume the appearance defaults of the host environment (for example, Microsoft's PocketPC and Windows XP), however, these can be varied by allowing more detail in the specification document 202, setting a separate set of defaults for the generator 104 and/or making adjustments during a later phase.

In an embodiment, position and size information may need to be generated for each component represented in a user interface segment 602. In such an embodiment, for each component identified in a user interface segment, the generator 104 uses an algorithm based on the number and type of text characters in the interface design area to calculate the type, position and size of each component contained therein.

The generator 104 then converts the respective specification statements into codes that are indicative of the type of component (for example, a control or label) represented by a specification statement and the calculated position and size. In terms of generating codes that are representative of controls, Table 6 provides various examples:

TABLE 6

| Control Component | Code |
|---|---|
| Command button | > |
| Label | L |
| Text Box | T |
| Check Box | c |
| List Box | ! |
| Data Grid | g |

It is to be appreciated that the above examples are not intended to be limiting. Codes can be allocated in a similar way for any available control component, for example, picture box or bitmap, combo box, progress bar date/time picker, tree view, menu, link label and standard dialogues (printer selection, file selection etc).

Size and position information for each component may be represented using any suitable code. In the present case, the generator 104 provides a code that includes numerical parameters indicating the location of the control on the screen and the size of the control. For example, where a form module includes a “button command” component specified as “[Take Order]”, the generator 104 converts this statement into the following code:

>Take Order-0043006401600023;

Where:
“Take Order” is the label for the command button;
“0043” is the position of the button relative to the left of the screen on the X axis (in pixels or equivalent unit of measure appropriate to the target-platform;
“0064” is the position of the button relative to the top of the screen on the Y axis (in pixels or equivalent unit of measure appropriate to the target-platform);
“0160” is the width of the button (in pixels or equivalent unit of measure appropriate to the target-platform);
“0023” is the height of the button (in pixels or equivalent unit of measure appropriate to the target-platform)”.

The algorithms also generate user interfaces that meet the standards of the targeted environment and that match the inferred format of the user interfaces as ‘drawn’ in the interface design area. However, as will be explained later, fine adjustments may be made during a refinement phase.

Prior to building the driver-code 204 for each component, the generator 104 accesses the DSA section 406 of the source file 204, to extract information necessary to recognise references to data items in the specification statements of the user interface segments 602 and to convert them to driver-code for execution against the physical data source(s) identified in the data access and storage module.

For example, the generator 104 may parse the source file 204 to identify statements binding a data source to a data item (for example, “Customer Name: Customer.Name”), and translate those references into an index into a specified database (for example, a reference to “Customer Name” in the specification will be translated as the “Name” column in a database table referred to as “Customer table” in the database access and storage module).

Although the generator 104 will typically generate one driver-code file 206 for each target-platform 106, it may also be implemented to deliver multiple driver-code files 204 from a single specification 202 for a single target-platform 106. Such may be the case where, for example, where a software system addresses a number of discreet user groups that required some variation in the user interface or workflow for each user group.

It is also possible to implement multi-platform driver-code files so that a single driver-code file 206 could execute on multiple target-platforms 106. For example, a driver-code file 206 may include an indicator to identify the target platform 106 and a different driver file name suffix for each target platform. However, this is a design choice; if the target-platform identifier was removed from the driver-code file and a generic driver-code file name suffix was used, the generated driver-code file would be identical for both target-platforms and function identically on both target-platforms within the limitations of each platform.

The generator 104 must convert data item references to their DSA section 406 specification ‘table’ and ‘column’ names and then to the physical database names to generate the appropriate driver code.

Options for connection strings to databases, initial SELECT statements for reading on relevant data may also be provided to ensure that the technical specification in relation to the physical infrastructure are confined to the DSA section 406 and to allow a degree of independence of the source file 204 from the physical database architecture.

To execute the coded functionality, the driver-code file requires an engine program that has been created specifically to read the driver-code file and deliver the functionality through the resident software infrastructure on the target-platform (for example, .Net or a JVM). A single host computing device only requires one engine program but it may store and process multiple driver-code files.

### SECOND EMBODIMENT

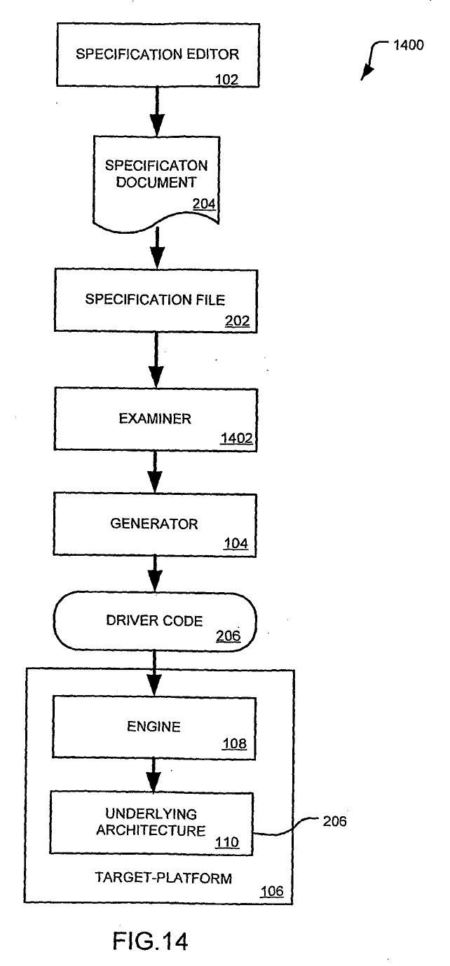

FIG. 14 illustrates a system 1400 according to a second embodiment of the present invention. System 1400 is substantially the same as system 100 with the exception that system 1400 further includes an examiner 1402 for verifying the completeness and correctness of a source file 204, and thus the associated specification document 202, prior to generation of a driver-code file 206.

Thus, in one embodiment, the invention further includes an examiner application 1402 (hereafter the ‘examiner’) for processing the specification 202 to verify correctness and completeness prior to generating the driver-code file.

In an embodiment, the examiner 1402 includes computer software including program instructions that are executable by a host-computer to read a source file 204 for a specification document 204 as input, and provide as an output, a modified source file 204 including codes identifying errors identified in the source file 204.

One suitable examiner 1402 includes a programmed computer equipped with executable instructions for parsing the specification against a set of formalised rules and modifying the system specification 202 to identify errors resulting from the parsing.

The formalised rules may include rules that specify the syntax of the specification language.

The examiner 1402 may include a separate computer application or it may be integrated within a larger application that provides other functions. In one embodiment, the examiner 1402 is provided as computer software resident on a host computer on which other computer software applications are provided, possibly including a software application(s) for editing or preparing a specification document 202 and the driver-code generator. For the purpose of this description, a computer application that conducts an examination process of the type described will be referred to as “an examiner”.

An examination process may be run against the source file 204 for a specification document 202 at any time during the preparation of a specification document 202 to check for completeness and correctness against the set of formalised rules. However, in one embodiment, a driver-code file 206 cannot be generated until the source file 202 for the specification document 202 has successfully completed an examination process.

The type of examination may vary. In one embodiment, an examination process parses the source file 204 to verify the completeness and correctness of essential specification statements included in the specification. For example, in one embodiment the examiner parses the source file 204 to verify that there are entries for the “System name” and “Host platform”, that there are “End” statements for each user interface segment, that all data items have a related data source specified, that all command buttons drawn on a form module have a related action, that a list drawn on a form module has an associated “List statement”, that all databases have a proper connection statement and, if necessary, a SELECT statement provided by a database administrator.

In one embodiment, errors, omissions or non-recognisable specification elements are highlighted in the source file 204 output by the examiner 1402.

In another embodiment, errors, omissions or non-recognisable elements of a source file 204 are displayed in a list of errors, and warnings to be addressed prior to generating the driver-code file 206.

In an embodiment in which an examination process is required to complete a source file 204 before a driver-code file 206 can be generated, a source file 204 cannot be completed, and thus a driver-code file 206 cannot be generated, until a successful examination process has been performed. Preferably, the completing of a source file 204 by an examination process includes the examiner building data requirement for the software system 101 (and thus for each target-platform) from the data elements identified in the specification document 202, and thus the source file 204 for that document.

### THIRD EMBODIMENT

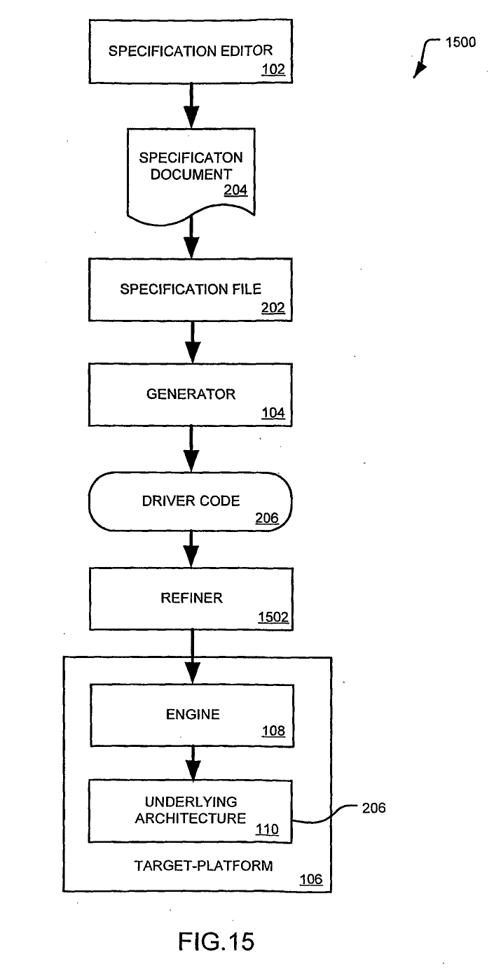

FIG. 15 illustrates a system 1500 according to a third embodiment of the present invention. System 1500 is substantially the same as system 100 with the exception that system 1500 further includes a refiner 1502 for adjusting the user interface designs prior to finalising the software system 101.

Thus, in one embodiment, the present invention further includes a refiner for modifying the user interfaces of the software system 101 so as to refine those interfaces in accordance with the user's desires.

In an embodiment, the refiner 1502 includes an input interface for accepting the driver-code file 206 and a reader for reading the driver-code file 206 so as to selectably display the program interfaces.

Preferably, the refiner 1502 includes a computer software including program instructions that are executable by a host-computer to read a driver-code file 206 as an input, and provide as an output, a display of a selected user interface specified in the specification document.

One suitable refiner 1502 includes a programmed computer equipped with a computer display screen and user input devices. The user input devices are configured to permit a user to select and manipulate one or more of the user interfaces so as to modify the appearance (that is, the ‘look and feel’) of the selected user interface. Such manipulation will enable a user to review each user interface (for example, a form) and make adjustments to its presentation properties interactively (that is by repositioning or resizing the program interface), including one or more of modifying its colour, changing font and size of text elements, and other adjustments to the appearance of the program interface that can be referenced in the driver-code file 206 and that have been enabled for modification by the refiner 1502. It is preferred that the driver-code file 206 reviewed by the refiner 1502 is updated in accordance with the results of the manipulation of the user interface.

### FOURTH EMBODIMENT

Another embodiment of a system according the present invention may include an examiner 1402 of the type described for the second embodiment and a refiner 1502 of the type described for the third embodiment.

### FIFTH EMBODIMENT

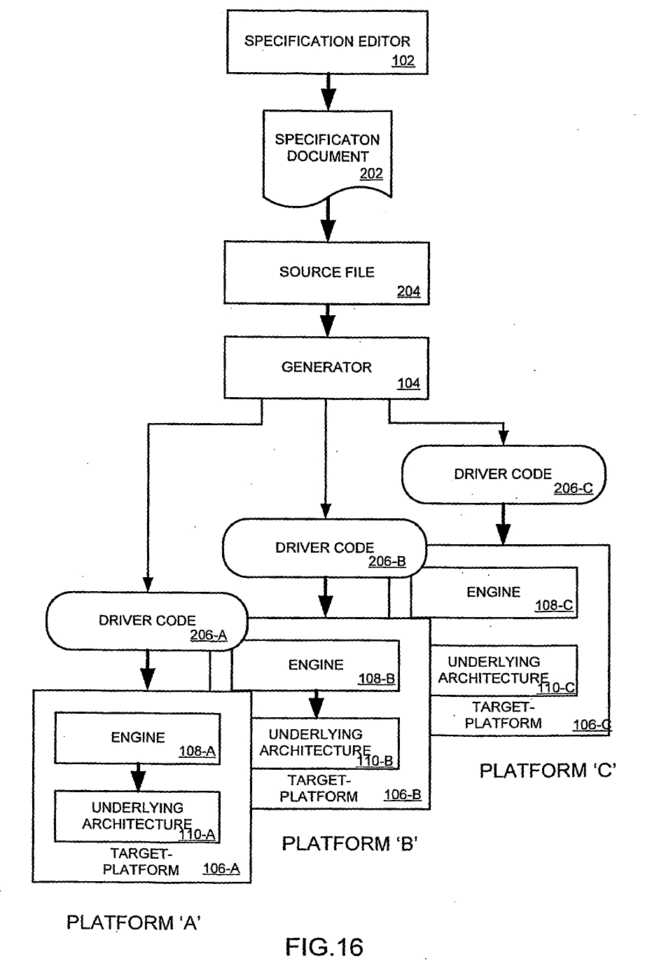

FIG. 16 illustrates a system according to a fifth embodiment of the present invention. In the embodiment illustrated in FIG. 16, the system is able to implement a software system for hosting by multiple target-platforms (shown here as ‘platform A’, ‘platform B’ and the ‘platform C’).

In this case the specification document 202 includes statements that collectively specify requirements of the software system 101 for the multiple specified target-platforms. In the present case, each requirement in the specification document 202 is from an allocation of requirements for each of the one or more target-platforms, each allocation encapsulating requirements allocated to a respective one of the target-platforms.

The driver-code generator 104 translates the source file into a separate driver-code files 206-A, 206-B, 206-C for each specified target-platform. Each driver-code file 206-A, 206-B, 206-C is readable by a run-time engine resident 108-A, 108-B, 108-C on a respective target-platform to provide, on execution of the driver-code file 206-A, 206-B, 206-C by the run-time engine 108-A, 108-B, 108-C, a software system compliant with the specified requirements for that target-platform.

Lexicon

As indicated previously, a specification document 202, and thus the associated source file 204, may include a lexicon section 608 that relates user defined terms with terms of increased complexity so as to render the specification more intuitive. Thus, a lexicon section 608 may be used to give meaning to phrases that are readily understood by the specification audience but require more specification for the computer. During generation of a driver-code file 206, the generator 104 will identify phrases that may need an entry in the lexicon 608 and the driver-code file 206 will not be generated until they are all resolved.

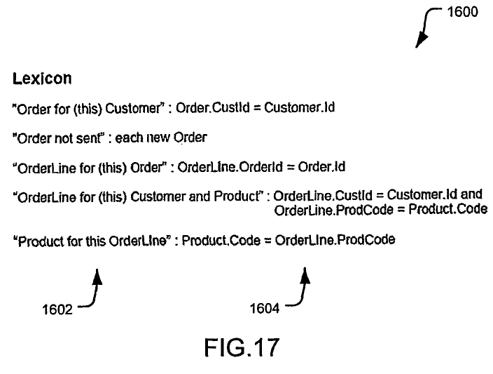

An example of a lexicon is included at FIG. 17 including examples of statements defining relationships between user defined statements 1602 and requirement statements of higher complexity 1604.

For example, with reference to the following statement:
“Order for (this) Customer”: Order.CustId=Customer.Id”

The phrase “Order for this Customer” is used within the specification document 202 because it a clearer way of defining the requirement to the whole specification audience. It's not required to put “this” in brackets; it is done here to highlight “this” as optional. The generator 104 will ignore it or any similar word or phrase in this position (for example, “the selected” or “the current” or “my”, or the like.).

In the above example, the key phrase is “Order for Customer”. The selection criteria implementing the specification phrase, is located on the right side of the colon. The generator will generate a driver-code file to suit the appropriate implementation environment, for example, setting of “dataviews” if working in disconnected mode within local memory or generating the appropriate SQL command(s) for database selection.

It should be noted that using the specification phrase “each Order where Order.CustId=Customer.Id” would deliver the same result without necessitating an entry in the Lexicon.

Engine

With reference to FIG. 1, the run-time engine 108 is required to read the driver-code file 206 and deliver the functionality through the resident software infrastructure (typically .Net or a JVM) on the target-platform 106. Each target-platform 106 will have an engine program 108. In an embodiment, the engine 108 is a software program created solely to process code from driver-code files 206 having a customised format. However, the engine 108 could equally be a general purpose engine, such as Microsoft's Common Language Run-time (CLR) for .Net. Ideally, a single engine can run multiple driver-code files 206 to implement multiple systems.

In summary then, the present invention provides an intuitive way of implementing a software system without the need for any programming on the part of the user. The required input and output formats, models and business processes are specified using a natural language in point form. The data sources and storage requirements are first identified as headings and progressively refined with further elaboration.

The present invention allows the use of a simple text editor or a commonly used word processor such as Microsoft Word to ‘whiteboard’ a software system using a simple method on a computer with minimal intrusion of technology.

If the specification document 202 is first prepared using a simple text editor (for example, NotePad), it can be later loaded into a word processor for improving the presentation of the specification document 202.

Alternatively, a specification document 202 first developed using the rich formatting capabilities of a word processor can be saved as a plain text file for processing by a generator. Variations of text editors/word processors could also be created to provide specific functionality designed to streamline the process of creating specifications files in accordance with embodiments of the present invention.

A method according to the present invention is expected to provide numerous advantages over existing software development methodologies. In particular, the use of the specification language supplies a means of concisely and consistently creating a system specification that will achieve the following objectives:
1. Allow all stake-holders to readily access and understand the specification; and
2. Permit the automatic generation of a running system directly derived from a complete and unambiguous specification.

As is evident from the preceding description, the specification language of the present invention includes a specification document format, rules for ‘drawing’ a draft layout of user interfaces (for example, forms to be displayed on computer display screens), rules for specifying the source of each data item, rules for specifying workflow and related actions, and scope for explanatory comments and system specification content that has no direct effect on the generation of a running system.

It is envisaged that different systems could be developed using the language and related tools of the present invention. Different computing platforms may be addressed using the inventive method and significant additional functionality may be added over the described examples.

For example, a system in accordance with the present invention may need to use specialised functionality that is not part of in-built functionality provided by the tools of the present invention. This functionality may already be provided by an existing software component or it may be decided that the functionality is so specialised and/or complex that it is best developed separately using a computer programming language such as Java or C/C++. A system, and method, according to the present invention can provide for this without corrupting its primary objectives.

Tools of the present invention can be enhanced to include this functionality as a standard part of the toolset, alternatively, the functionality can stay outside the scope of the tools and still be included in a system according to the present invention. In one embodiment, the specification language is exactly the same for both an integrated standard function and an equivalent external function except that it is recommended that the referencing specification statement for an external function indicate that it is external, for example, by prefacing the name of the software component with ‘External’. This will indicate to the system stakeholders that this is a separately developed software component and it will allow any external software dependencies to be easily found in the specification document 202.

The specification of a call to an external function would typically include explanatory text to describe the desired functionality in terms that can be understood by all system stakeholders.

The driver-code generator 104 and the engine 108 may cater for calls to external software components within the workflow of the specification; this would be within the capabilities of persons skilled in programming for the target environment of the engine 108.

An external component may be outside the control of the owners of the system so source code documentation of the external component cannot be updated with the same reference that locks the system specification and driver files together, however, the specification that references the external component and the driver code can still be locked together and all external software component dependencies can be easily located within the system specification for management. The overall management of a system, even with calls to external software components, is expected to be superior to current methods.

Appendix A, Appendix B and Appendix C relate to an example of a specification document prepared in a specification language suitable for use with an embodiment of the present invention. In particular, Appendix A is an example of a specification document prepared for a single target-platform. Appendix B is the specification document of Appendix A with explanatory comments. Appendix C is the specification document of Appendix A with driver code fragments and explanatory comments related thereto.

The examples are intended to assist the reader in understanding the format and role of a specification document suitable for use with an embodiment of the present invention. In this respect, the examples focus on functional requirement segments of a system specification (and thus only include minimal non-functional requirements). It is to be appreciated that the following examples are not intended to limit the scope of the present invention.

It will be understood that there may be other variations and modifications to the configurations described herein that are also within the scope of the present invention.

1. A method of implementing a software system on a target-platform, the method including:
preparing a specification document including statements that collectively specify requirements of the software system, the requirement statements expressed with language elements of a specification language, the specification document having an associated source file;
providing the source file to a driver-code generator; and
the driver-code generator translating the source file into a driver-code file readable by a run-time engine resident on the target-platform to provide, on execution of the driver-code file by the run-time engine, a software system compliant with the specified requirements.

2. A method according to claim 1 wherein the source file is a text file.

3. A method according to claim 1 wherein the specification document includes:
a non-functional requirement section containing statements expressing non-functional requirements;
a functional requirement section containing statements expressing functional characteristics of the software system; and
a data section containing statements defining connections between the software system and external data sources;
wherein the translation of the source file into a driver-code file that is readable by a run-time engine resident on the target-platform includes only translating the statements of the functional section and the statements of the data section.

4. A method according to claim 3 wherein the functional requirement section includes one or more user interface segments, each user interface segment for a user interface of the software system and including:
a layout design area including a simplified layout of an arrangement of components for a respective user interface; and
a function specification area including expressions specifying an action, or event, associated with at least some of the components of the user interface;
wherein after translation, the driver-code contains size and position information for each component, derived from the simplified layout, and wherein the driver-code also contains event information derived from the function specification area, for each specified action or event.

5. A method according to claim 4 wherein at least some of the components of an interface segment have a specified association with a data item, and wherein the interface segment further includes a data area containing statements binding each data item to a data source specified in the data section of the specification document.

6. A method according to claim 1 wherein the specification document specifies multiple target-platforms, and wherein the driver-code generator translates the source file for the specification document into a separate driver-code file for each specified target-platform.

7. A method according to claim 1 wherein during generation of the driver-code file a unique matching reference is written to the, or each, driver-code file and the source file.

8. A method according to claim 1 further including inputting the source file into an examiner application for verifying the completeness and correctness of the source file against a predefined set of formalised rules.

9. A system for implementing a software system, the system including:
a specification editor for preparing a specification document including statements that collectively specify requirements of a software system for one or more target-platforms, the requirement statements expressed with language elements of a specification language, the specification document having an associated source file; and
a driver-code generator for accepting the source file as an input and translating the source file into a separate driver-code file for each specified target-platform, each driver-code file readable by a run-time engine resident on a respective target platform to provide, on execution of the driver-code file by the run-time engine, a software system compliant with the specified requirements.

10. A system according to claim 9 wherein the specification editor includes a word processor.

11. A programmed computer including:
an input interface for accepting a source file for a specification document, the specification document including statements that collectively specify requirements of a software system for a specified target-platform, the requirement statements expressed with language elements of a specification language; and
a processor programmed with computer software for parsing the source file to generate, as an output, a driver-code file for deployment on a run-time engine of the target-platform to provide, on deployment, a computer software system compliant with the computer software system specification.

12. A software system including:
a run-time engine;
an underlying software architecture interfacing with the run-time engine;
a driver-code file, including a set of coded instructions that are executable by the run-time engine;
wherein the driver-code file has been generated by translating a source file for a specification document, the specification document including statements that collectively specify requirements of the software system and that are expressed with language elements of a specification language,
and wherein on execution of the driver-code file by the run-time engine, the software system complies with the specified requirements.

13. A software development system, including:
a specification editor, operable by a user to produce a specification document including statements that collectively specify requirements of a software system for one or more target-platforms, the requirement statements expressed with language elements of a specification language, the specification document having an associated source file;
a parser for parsing the source file and comparing the contents against a predefined set of formalised rules to verify the completeness and correctness of the source file; and
a generator for translating the source file into a driver-code file for each specified target-platform, each driver-code file being readable by a run-time engine resident on the respective target platform to provide, on execution of the driver-code file by the run-time engine, a software system compliant with the specified requirements.

14. A programmed computer, including:
a computer readable media containing a driver-code file, the driver-code file including a set of coded instructions generated by translating a source file for a specification document, the specification document including statements that collectively specify requirements of the software system and that are expressed with language elements of a specification language, and a graphical and/or textual layout of one or more graphical user interfaces for user display and interaction;
a processor programmed with computer software for:
executing the driver-code file to provide, at an output display, a graphical representation of one or more of the graphical user interfaces;
allowing a user to manipulate a displayed graphical user interface, using an input device, to modify visual characteristics of the one or more of the graphical user interfaces; and
updating the driver-code file in accordance with the user manipulation of the one or more of the graphical user interfaces.

15. A computer readable media including computer software for execution by a programmed computer to:
accept a source file for a specification document, the specification document including statements that collectively specify requirements of a software system for a specified target-platform, the requirement statements expressed with language elements of a specification language; and
parse the source file to generate, as an output, a driver-code file for deployment on a run-time engine of the target-platform to provide, on deployment, a computer software system compliant with the computer software system specification.

16. A computer readable media including computer software for execution by a programmed computer to:
accept, as an input, a driver-code file including a set of coded instructions generated by translating a source file for a specification document, the specification document including statements that collectively specify requirements of the software system and that are expressed with language elements of a specification language, and a graphical and/or textual layout of one or more graphical user interfaces for user display and interaction;
execute the driver-code file to provide, at an output display, a graphical representation of one or more of the graphical user interfaces;
allow a user to manipulate a displayed graphical user interfaces, using an input device, to modify visual characteristics of the one or more of the graphical user interfaces; and
update the driver-code file in accordance with the user manipulation of the one or more of the graphical user interfaces.

17. A method of implementing a software system for hosting by multiple target-platform, the method including:
preparing a specification document including statements that collectively specify requirements of the software system for multiple specified target-platforms, the specification document having an associated source file;
providing the source file to a driver-code generator; and
the driver-code generator translating the source file into a separate driver-code file for each specified target-platform, each driver-code file readable by a run-time engine resident on a respective target-platform to provide, on execution of the driver-code file by the run-time engine, a software system compliant with the specified requirements for that target-platform.

18. A method of implementing a software system for one or more target-platforms, the method including:
preparing a specification document including requirement statements that collectively specify requirements of the software system, each requirement from an allocation of requirements for each of the one or more target-platforms, the requirement statements expressed with language elements of a specification language, the specification document having one or more associated sets of source files, each set of source files containing information encapsulating requirements allocated to a respective one of the target-platforms;
providing each set of source files to a driver-code generator; and
the driver-code generator translating the respective set of source files into a driver-code file readable by a run-time engine resident on the respective target-platform to provide, on execution of each driver-code file by the run-time engine, a software system compliant with the specified requirements for that target-platform.

19. A method of implementing a software system on a target-platform, the method substantially as hereinbefore described with reference to the examples and accompanying drawings.

20. A software development system substantially as hereinbefore described with reference to the accompanying drawings.

21. A specification language substantially as hereinbefore described with reference to the examples.

22. A method of implementing a software system on a target-platform, the method including:
preparing a system specification document singularly encapsulating the functional and non-functional requirements, the system specification including requirement statements, in text form, expressed with language elements of a specification language, the specification document having a source file; and
a run-time engine resident on the target-platform generating executable code directly from the source file, the executable code being executable by the run-time engine to implement the software system such that the implemented software system complies with the specified functional requirements, and wherein the software system is generated without generating intermediate code containing a set of instructions in the form of a computer programming language.

23. A method according to claim 22 wherein the source file is one of:
(a) a word processing file; or
(b) a text file.

24. A method according to claim 23 wherein the executable code is in the form of either a driver-code file or a native code file.

25. A method according to claim 24 wherein the executable code is generated to include a unique reference identifier, and wherein the unique reference identifier is automatically written to the source file before implementation of the software system so as to identify the corresponding source file.

26. A method according to claim 22 wherein the software system is a business software system.

27. A method according to claim 6 wherein during generation of the driver-code file a unique matching reference is written to the, or each, driver-code file and the source file.
